(19) United States
(12) Patent Application Publication
(10) Pub. No.: US 2016/0011293 A1
(43) Pub. Date: Jan. 14, 2016

(54) Dual Axis Solar Tracker with Elongated Slats, Chronological Daily Tracking, and Decoupled Axes

(71) Applicant: Elliot Stewart Tarabour, Clarendon Hills, IL (US)

(72) Inventor: Elliot Stewart Tarabour, Clarendon Hills, IL (US)

(21) Appl. No.: 14/664,551

(22) Filed: Mar. 20, 2015

Related U.S. Application Data
(60) Provisional application No. 61/967,633, filed on Mar. 24, 2014.

(51) Int. Cl. G01S 3/786

(52) U.S. Cl. CPC G01S 3/7861

(57) ABSTRACT

A solar tracker with elongated slats is disclosed. By redesigning the optimal shape of the slats and having this device dictate the shape of slat, the tracker will reduce cost of tracking by allowing a tracking motor to achieve a significantly larger area with the same energy output. These gains are so significant that chronological daily tracking is invoked, reducing the maintenance requirements on the motors while still consuming less energy than existing tracking systems. Wires are kept from twisting by a subcomponent. The seasonal tracking (if implemented) is decoupled and accomplished by traditional methods.

### BACKGROUND

Solar trackers have been used to enhance the efficiency of solar devices, but at an additional cost in both expense and energy. There are a variety of ways this can be accomplished via single axis tracking vs. dual axis tracking The later improves efficiency but also incurs more expense. Trackers must be used for concentrated applications. (CPV and CSP) but their use in conjunction with non-concentrated solar panels is strictly a case of economics, not the least of which is the cost of land utilized for a particular project. Since the efficiency is increased by tracking the same power can be derived by a smaller footprint using tracking

In reviewing the history of solar energy, the cost of solar cells was the majority of expense in solar applications. We find that trackers were designed to conform to cells, panels, or other targets were used for these devices. They were considered as an adjunct to the system. One form of tracking that has fallen into disfavor is chronological tracking, which is much simpler to implement, but was abandoned by current tracking manufacturers due to three primary reasons: 1) the energy budget for chronological trackers was at the time higher, 2) the clearance requirements for these type of trackers impacted their use and, 3) the fact that wires were in continuous rotation vs. a back and forth motion led to a twisting of the wires, which had to be addressed.

However since the economics of trackers are now a more significant portion of the total system cost, in this invention, we are looking to having the solar cells mounted on slats conform to the tracker instead of having the tracker conforming to the panels or cells. In the current device we can quantify a significant savings in the energy utilized by the device so that chronological tracking is reintroduced. The net is improved economics overall from an energy consumption perspective by a factor of approximately 3. Additionally the redesign solves the clearance problem associated with chronological trackers. The combination of redesign of tracker geometry and the use of the currently disfavored chronological tracking for daily tracking and the decoupling of this tracking from seasonal tracking in the disclosed device will prove superior economically to other trackers publicly available.

### BRIEF SUMMARY OF THE INVENTION

The apparatus tracks sunlight in both a longitudinal and latitudinal axes simultaneously but does so via decoupled tracking mechanisms. The device can be used in only one dimension and not track latitude. The novel component of the apparatus is the discovery of a geometric way to reduce the energy required for tracking The physics behind this leads to the conclusion that an elongated thin shape is much more efficient with the thinner dimension utilized for the daily tracking This suggests that shape should follow the tracker instead of the tracker following a predetermined geometric arrangement of cells into standard panels. Since this shape allows for a smaller clearance requirement, chronological tracking is utilized which consumes more energy given a 24 hour operation, but the total net energy used is lower. Chronological tracking should reduce maintenance of the motors vs. the current more complex motion currently utilized.

The disclosed apparatus makes use of this novel geometry which minimizes moment of inertia in the daily tracking direction to accomplish the tracking. The device is also more reliable and the linkage of individual slats for tracking makes the tracker an economically attractive alternative.

### DESCRIPTION OF THE PRIOR ART

Since this approach is an entirely new approach we find that there is limited prior art for the apparatus as disclosed. All the individual components are standard and each one is well understood. No claims are made for the individual components. It is the novel arrangement of elements that constitute the essence of the invention disclosed herein. One patent that may have peripheral applicability is:

20140053825—Ganged single axis solar tracker and its drive system. We find this patent links trackers together in a single axis but there is no mention of elongated geometry, dual axes, or chronological tracking There are multiple slats linked together in the disclosed apparatus which will save energy on the motor. That is the only similarity.

### BRIEF DESCRIPTION OF THE DRAWINGS

FIG. 1 shows a side view of the apparatus.

FIG. 2 show detail of certain components

FIG. 3 shows the physics behind the invention

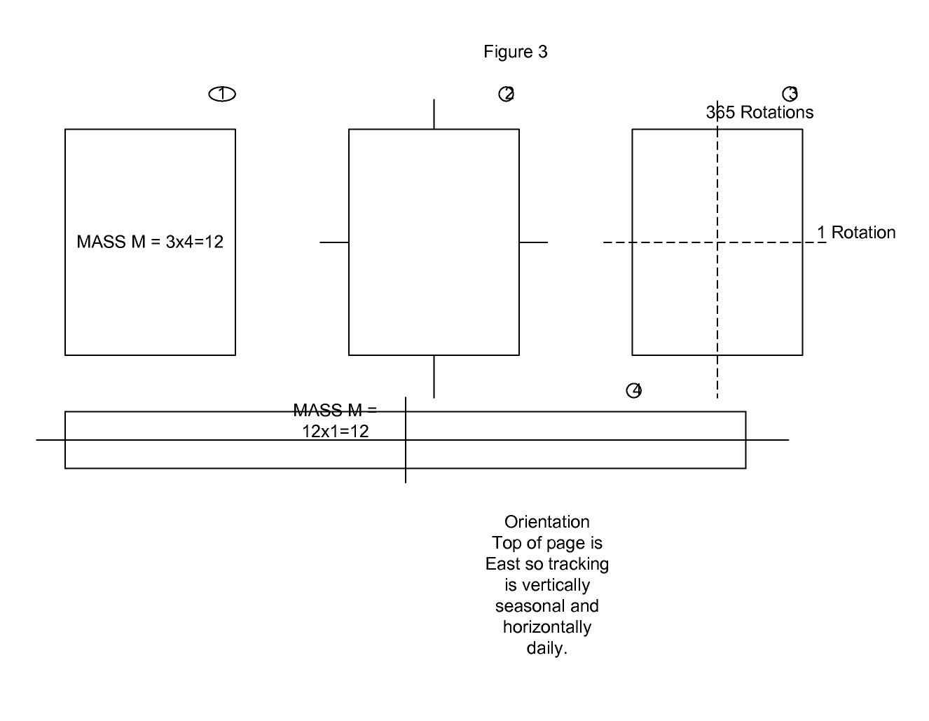

FIG. 4 shows a top view of the apparatus

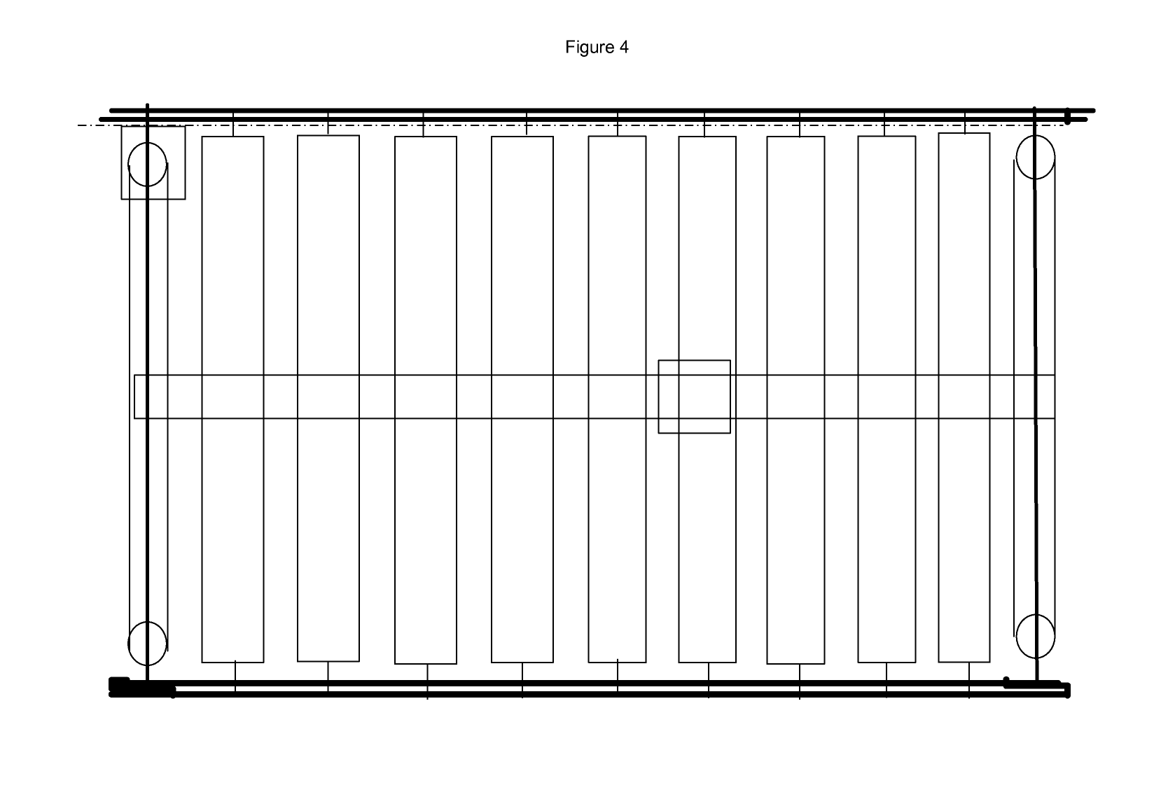

FIG. 5 shows a front view of the apparatus

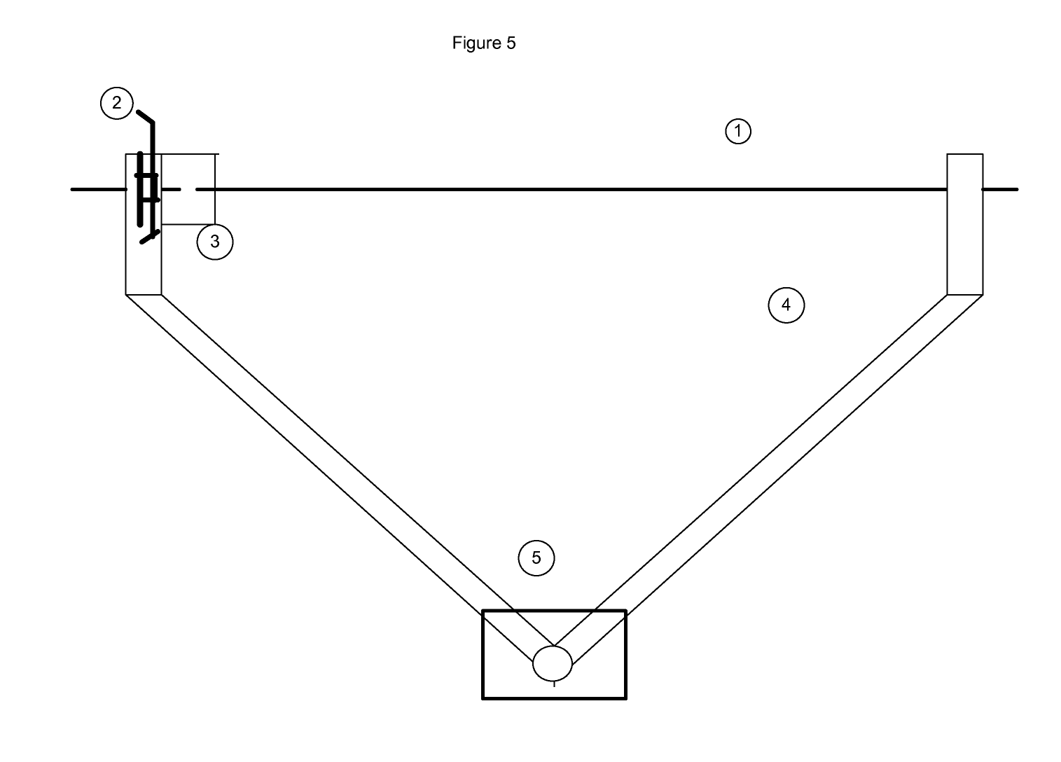

### DETAILED DESCRIPTION AND EMBODIMENT OF IMPLEMENTATION

At the outset, I will apologize for the quality of the drawings. In an ideal world they would be more comprehensive and detailed. Having said this, the drawings are believed to be sufficient, along with the accompanying narrative to allow one of ordinary skilled in the art to make this apparatus. The reason is that this is a simple device to construct and no components involve any new technique.

Definitions: We are defining several components to make details regarding the implementation concise and clear.
Slat—A subcomponent consisting of a single panel of solar cells mounted on an elongated substrate with rotational rods at both ends. Wiring is provided at one end (either positive and negative or positive, negative and, ground) as required. The slat in this embodiment does not contain any inverter or partial inversion function. These elements are per the claims, not foreclosed.
Retrograde gear and sprocket—The gear and sprocket which engages with the large gear to facilitate the individual wiring sprockets to untwist during the retrograde motion. to the slat.
Rotating wiring sprockets—They plug into the Fixed wiring receptacles during the energy transmission phase but are disconnected during retrograde phase. These are linked with a timing chain.
Fixed wiring receptacles—The units firmly attached to the stationary bar. These directly interface with the individual wiring sprockets to transmit the electricity but are disengaged during the retrograde phase.

Other general instructions are to make all bracing and connectors strong enough to accomplish their purpose yet as light as possible. The addition of additional bracing for stability and the use of weather resistant materials should be assumed and will be determined by the actual deployment and testing of the apparatus. All attachments of a permanent nature are assumed to be welding, bolt, etc. in accordance with current best practices.

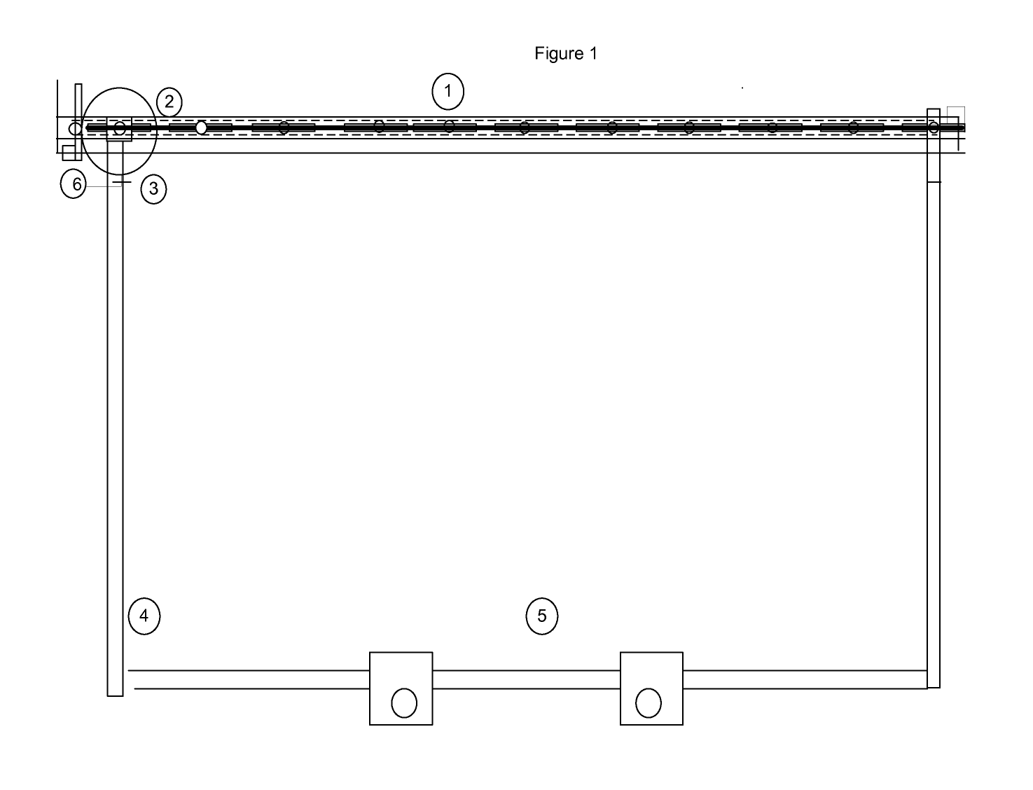

Construction of the device begins with affixing (weld or bolt) each of the four structures that are supports to the central core of the apparatus as depicted in FIG. 1 #5. The central core is steel pipe which is 12 meters long with a diameter of 5 centimeters and a thickness of 2 centimeters. The supporting posts are 15 meters long also with a diameter of 5 centimeters and a thickness of 2 centimeters with the uppermost section curved at angle so it is parallel to the other posts the top FIG. 1 #4. A hole is placed in each supporting post to allow the axle rotated by the motor FIG. 1 #2 to pass through the post. The axle is attached to a rigid post of length 6 meters width of 1 centimeter and height of 3 centimeters. This post is connected rigidly to a long rod of length 11 meters, by individually connecting rods to which the rotational axis for each slat. By way of analogy a rotisserie where a number of items are simultaneously rotated by a single motor are attached. The axle for rotation of the slats passes through a rigid rod FIG. 1 #1 attached to corners of the device FIG. 1 #2. The holes for these are 1.05 meters apart. The slats are attached to these rods and rotate freely as the external rod will act as a translator of the rotation supplied by the motor.

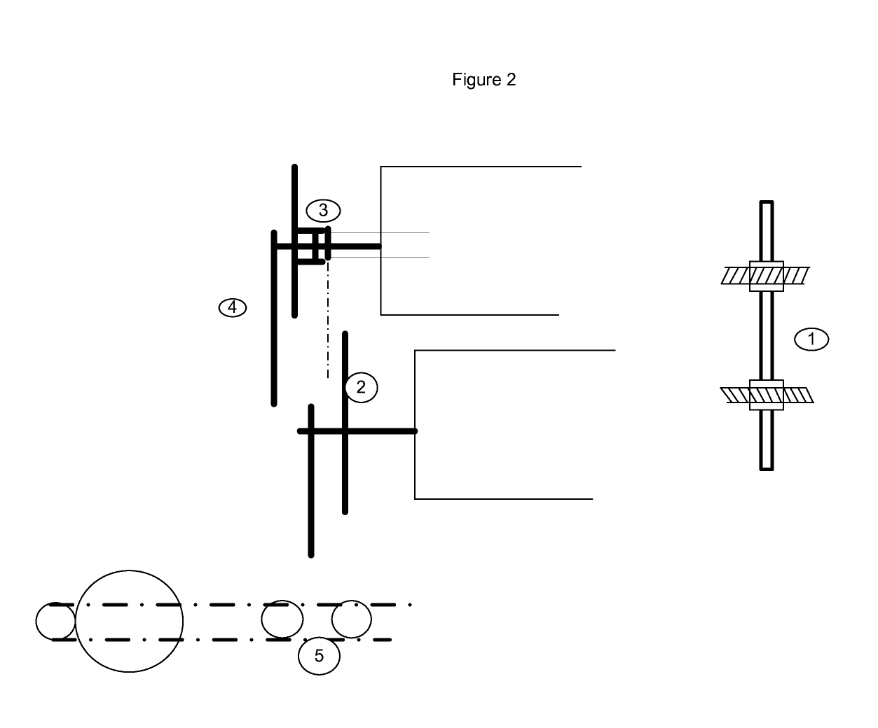

Since the rotational motion is continual in a single direction, any wires coming from the slats will inherently twist. This has been addressed by adding a 2 phase approach to the operation of this device. In the normal phase the fixed wiring receptacles rotating wiring sprockets are stationary during this phase. In the retrograde phase the rotating wiring sprockets are disengaged and a set of gears will lead to a retrograde motion through the use of a timing chain of one revolution. This will untwist the wires. The gear ratio between the large gear on the basic rotational axis and the gear with the timing chain will be 8 to 1. This will lead to a retrograde phase of 3 hours comprising the period between midnight and 3:00 AM. FIG. 2 shows these components in greater detail.

Seasonal tracking is done by 2 large slewing motors at the base FIG. 2 #1. These are set in opposite operational directions but can be used for redundancy.

This application was submitted as a provisional application. The application number is 61/967,633. The filing date on that application was Mar. 24, 2014. It is believed the benefit of that filing accrues.

1. We claim an improved device to track the sun as disclosed herein.

2. We claim an elongated slat as described with a width to length ratio of greater than 5.

3. We claim an embodiment of the device of claim 1 where the seasonal tracking is accomplished by manual means at fixed intervals.

4. We claim an embodiment of the device in claim 1 for rooftop use including no seasonal tracking.

5. We claim an embodiment of the device in claim 1 where the legs in the westerly direction are shorter to address duck slope concerns.

6. We claim an embodiment of the device in claim 1 where wiring is provided in serial or parallel between the fixed wiring receptacles.

7. We claim an embodiment of the device in claim 1 where an inversion function is integrated. This may or may not include partial inversion functionality at the slat level.

8. We claim an embodiment of the device in claim 1 where the spacing between holes in the rigid rod may vary due to shading considerations.

9. We claim an embodiment of the device in claim 1 where no seasonal tracking is implemented and 4 posts provide the support.

10. We claim embodiments of the device in claim 1 where any dimension is varied from those included herein in keeping with the spirit of the disclosure.

11. We claim an embodiment of the device in claim 1 where a redundant motor is provided.

12. We claim an embodiment of the device in claim 1 where multiple devices are linked together with a single motor.

13. We claim an embodiment of the device in claim 1 where the rigid rods along the sides can be replaced by a hemispheric cap or any other rigid shape to accomplish optimal performance.

14. We claim an embodiment of the subcomponent in claim 2 where the slat is not rigid but may contain a midpoint break in the slat for ease of installation

15. We claim a mechanism for untwisting wires as disclosed herein. We however reserved the right to use other methods including wireless transmission, brushes, or any other method for providing the functional equivalent that will improve the device.
